(19) United States
(12) Patent Application Publication
(10) Pub. No.: US 2010/0274375 A1
(43) Pub. Date: Oct. 28, 2010

(54) Method and system for making reliefs and sculptures

(75) Inventor: Wolfgang Daum, Groton, MA (US)

Correspondence Address: Wolfgang Daum;Team-At-Work, Inc., 20 Whiley Road, Groton, MA, 01450, US

(73) Assignee: Team-At-Work, Inc., Groton, MA (US)

(21) Appl. No.: 12/070,453

(22) Filed: Feb. 19, 2008

Related U.S. Application Data
(60) Provisional application No. 60/902,481, filed on Feb. 21, 2007.

(51) Int. Cl. G05B 19/4097

(52) U.S. Cl. 700/98; 700/118

(57) ABSTRACT

Disclosed is a method and system for creating a relief or sculpture from an object. More specifically the present invention relates to methods for creating a relief or sculpture from a human model utilizing software to reconstruct a 3D data set from 2D images of the human model and shaping the relief or sculpture using computer numerical controlled milling machines.

### TECHNICAL FIELD

The present invention relates to methods for creating a relief or sculpture from a human subject. More specifically the present invention relates to methods for creating a relief or sculpture from a human subject utilizing software to reconstruct a 3D data set from 2D images of the human subject and shaping the relief or sculpture using computer numerical controlled milling machines.

### BACKGROUND

Reliefs and sculptures from human subject can be decorative assets. However, traditional reliefs and sculptures are fabricated by hand, which is time consuming, rather expensive and the quality of the work varies according to the skills and mood of the artist. The intend of the present invention is to provide an inexpensive and fast method to fabricate high quality reliefs and sculptures replicating the human subject 3D image.

U.S. Pat. No. 7,133,734 teaches a method for sculpting whereas the sculpture is cut out of a piece of material using computer numeric controls. However, the method does not teach a method to render a high quality replicate of the human subject.

US 2005/0053275 teaches a system to model a three-dimensional (3D) object comprising an image acquiring means arranged to receive a single two-dimensional (2D) image of a subject. However, in praxis the quality of a 3D object which is reconstructed from a single 2D image is fairly poor.

Constructing a 3D data set from multiple 2D images of a scene is a fundamental problem in computer vision and image-based modeling. A fundamental problem in 3D image reconstruction is assigning correspondences between points in two or more images that are projections of the same point in the original 3D scene. Various method to reconstruct a 3D image from 2D images are known in the literature: Multi-view stereo methods construct 3D models by automatically determining pixel correspondences in multiple images. Stereo correspondence methods work well when the distance between different viewpoints—often called the baseline—is small. Shape-from-silhouette methods construct the 3D model as an intersection of visual rays from the center of projection of the camera through all points in object silhouettes. Voxel coloring can be used to gradually carve out voxels from a 3D volume that are not color-consistent with any image pixels to which the voxels project. Image-based modeling methods typically split the task of 3D model construction between the user and the computer. Some methods construct a model from a single image using user-defined billboards or user tools to paint depth images, edit the model, and change the illumination in images.

The aim of the present invention is not to disclose a new 3D rendering mechanism or a new mechanism to sense 3D objects, but to disclose an application how to utilize those algorithms for a system in which someone obtains a 3D sculpture or relief of himself. 3D rendering algorithms and algorithms to sense 3D objects can be found for instance in patent classifications G06T1 ff. A method for modeling a three-dimensional object by acquiring data from multiple viewpoints can be found for instance in U.S. Pat. No. 6,831,641 and other filings of the same group of inventors.

Computer Numerical Controlled (CNC) milling machines are commonly used to fabricate mechanical components by the selective removal of material from a work piece. CNC does numerically directed interpolation of a cutting tool in the work envelope of a machine. CNC milling machines allows the production of curves as easy as straight lines. Complex three dimensional structures are relatively easy to produce, and the number of machining steps that required human action are dramatically reduced. With the increased automation of manufacturing processes with CNC machining, considerable improvements in consistency and quality have been achieved. CNC automation also allows for more flexibility in the way parts are held in the manufacturing process and the time required to change the machine to produce different components.

The most basic motion for a controller is to move the machine tool along a linear path from one point to another. All motions can be built from linear motions as long as if they are short and there are enough of them. But most controllers can interpolate circular arcs in spatial X, Y and Z coordinates. Modern machine tools have a magazine of different tools which automatically can be changed pneumatically, hydraulically, and electromechanically.

A more recent advancement in CNC interpreters is support of logical commands, known as parametric programming. Various manufacturers refer to parametric programming in brand-specific ways.

A wood CNC Router is similar to a metal CNC mill, but with some differences. The wood router typically spins faster-up to 24,000 rounds per minute, uses smaller tools, and tool holders. Some wood routers have multiple separate heads that are able to come down simultaneously or separately. Wood routers are generally much bigger than their metal shop counterparts. A wood router is controlled in the same way as a metal mill, plus additional software specifically for wood routers. Wood with different grain of different alignment, texture and appearance of the wood fibers, must be approached with unique strategies. Basic grain descriptions and types include straight grain, which runs in a single direction along the cut wood, cross grain, in which some cells grow out from the major growth axis of the tree, spiral grain, which develops as the trunk of the tree twists in its development, and interlocked grain. In addition, there are a few special grain alignments, such as bird's eye, quilted, fiddle-back, curly, and tiger. In describing the application of a woodworking technique to a given piece of wood, the direction of the technique may be with the grain, against the grain, or across the grain. In a wider sense, the term grain may also be applied to the orientation of the cut, the way a given piece of wood has been sawn, such as flat-grain which is flat-sawn, or plain sawn, edge grain, which is quarter-sawn or rift-sawn or straight-grained, and end grain.

### SUMMARY OF THE INVENTION

The goal of the present invention is to provide an inexpensive and fast way to fabricate reliefs and sculptures replicating the human subject's 3D image in a highly qualitative form from two dimensional (2D) images utilizing software to reconstruct a 3D data set from these 2D images of the human subject and shaping the relief or sculpture using computer numerical controlled milling machines.

The above summary of the present invention is not intended to describe each illustrated embodiment or every implementation of the present invention. The figures and the detailed description which follow particularly exemplify these embodiments.

### BRIEF DESCRIPTION OF THE DRAWINGS

FIG. 1 illustrates an example of the system in which the user has a computer or a phone with digital camera, appropriate software and light to illumine him or herself or any object he or she likes to make a 3D model or relief from.

### DETAILED DESCRIPTION OF EXEMPLARY EMBODIMENTS

The term “sculpture”, as used herein, refers to a three dimensional object. The term “relief”, as used herein, refers to a three dimensional object constructed out of a flat background. In general the object will be a human subject, the whole human body, or just body parts like preferably the head or the head and parts of the torso. Thus, the term “subject”, as used herein, refers to the whole human body, or just body parts like preferably the head or the head and parts of the torso. The term “work piece”, as used herein, refers to a piece of material capable of being milled in a CNC milling machine. A work piece can be made from materials such as glass, wood composites, stone, plastic, metal or any combination thereof. The term “image”, as used herein, refers to a digital or digitalized analog photograph of an object. The term “information device”, as used herein, refers to any electronic device capable of processing and displaying graphical data. An information device can be a computer, laptop, personal data assistant (PDA), mobile phone or any other device with some of the functionality of a computer. An information device may comprise a camera.

The abbreviation “2D”, as used herein, refers to two dimensional and the abbreviation “3D”, as used herein, refers to three dimensional. The abbreviation CNC, as used herein, refers to computer numerical controlled.

It is to be understood that the singular forms of “a”, “an”, and “the”, as used herein and in the appended claims, include plural reference unless the context clearly dictates otherwise.

In general the disclosed method for creating a sculpture consists of the steps of a) taking at least two 2D images of a subject, b) applying an algorithm to recreate a 3D dataset of the surface of the subject, c) creating from this 3D dataset CNC code for milling the sculpture of the subject and d) milling the work piece using this CNC code.

In general the disclosed method for creating a relief consists of the steps of a) taking at least two 2D images of the subject, b) applying an algorithm to recreate a 3D dataset of the surface of the subject leaving a flat background, c) creating from this 3D dataset CNC code for milling the relief of the subject and d) milling the work piece using this CNC code.

In one embodiment of the invention a 3D image of the subject is presented on the graphical display of an information device for an operator to define the boundaries at which the sculpture or relief will be cut-off.

In one embodiment of the invention an algorithm modifies the 3D dataset in such a way that the resulting relief or sculpture appears in a preferred art or artistic style. The relief can be a bas-relief (pronounced “bah”), or low relief, with the background compressed for depth. The relief can be an alto-relievo, or high relief, where the image is highly undercut and rendered almost in the round against its flat background. The relief can be a sunken-relief, also known as intaglio or hollow-relief, where the image is carved into the work piece, creating in effect a negative, in contrast to other types of relief work where the surrounding stone is carved away to leave the image. An art or artistic style can make the sculpture or relief appear in a more abstract style such as a cubistic style or virtuosic style.

In general, the system for creating a sculpture or a relief from a subject comprises a digital camera, a computer capable of running at least 3D reconstruction software and CNC software and a CNC milling machine capable of reading the CNC code.

In one embodiment of the present invention the user who wishes to create a relief or sculpture of himself connects online to an Internet web site which offers the relief or sculpture service. The user has a digital camera connected to his computer or phone. The automated algorithm asks the user to pose in different angels in front of the camera to create a couple of 2D images of the user from various lateral or horizontal view points. Or the user is asked to slowly rotate in front of the running camera to create a short movie. From these static or moving 2D images or movie the algorithm creates a 3D image (by using such algorithms as described in the Background section or other algorithms) which is presented to the user. The user can now choose where he wants the 3D to be cut-off or where the background of the relief should cut through the 3D image, the artistic style and from which material he wants his relief or sculpture to be fabricated. After providing address, payment information and possibly further private information the user submits the relief or sculpture making process. The so created and modified 3D data set is then transformed to an CNC milling algorithm and the milling is started in an appropriate factory. A time later the user will receive his relief or sculpture by mail.

In one embodiment of the invention an operator will help the user to position himself in front of the camera and to modify the image. This support can be done online or in a dedicated location. Such a dedicated location can be a photographer located near to the user.

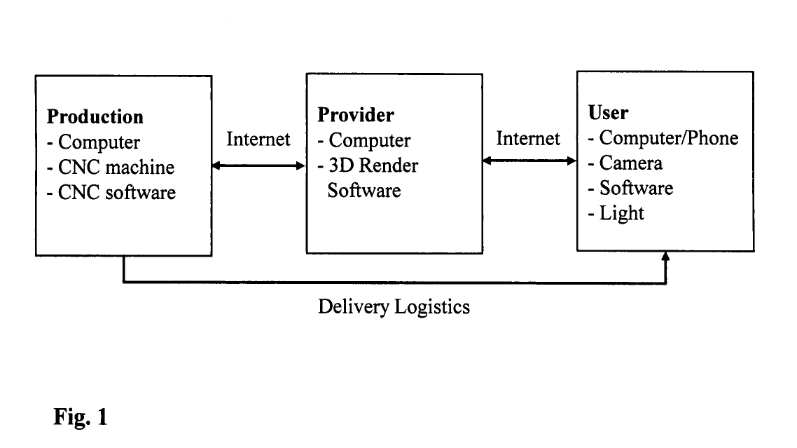

FIG. 1 shows an example of the system in which the user has a computer or a phone with digital camera, appropriate software and light to illumine himself or any object he likes to make a 3D model or relief from. The user connects via the Internet or phone line (not shown in the FIGURE) to the provider who offers the 3D model or relief service. The provider has a computer or server with appropriate 3D render software. As described above, the user is asked to pose in various ways in front of his one camera or multiple cameras. The provider is connected via the Internet or his Intranet (not shown in this FIGURE) with a 3D model or relief production facility. The production facility or in short just production also has a computer or server and a CNC or similar machinery capable of carving, tooling, in general working a 3D structure from a block of material, and software allowing to drive or control the CNC machine to work a 3D model or relief from the rendered 3D model of the user or the user's object. Production will send the so shaped and build 3D relief or model via a delivery logistics, which can be postal mail or a delivery service, to the user.

In one embodiment of the invention does the method for providing a sculpture comprises the steps of a) taking at least two 2D images of a subject, b) applying an algorithm to create a 3D dataset of the surface of the subject, c) defining boundaries and art style of the sculpture, d) creating from this 3D dataset CNC code for milling the sculpture of the object, and d) milling the work piece using this CNC code. The method as described can further be characterized in which a 3D image of the object is graphically presented to an operator to define the boundaries at which the sculpture or relief will be cut-off.

In one embodiment of the invention does the method for creating a relief or sculpture consists of the steps of a) taking at least two 2D images of a subject, b) applying an algorithm to create a 3D dataset of the surface of the subject leaving a flat background, c) defining boundaries and art style of the relief, d) creating from this 3D dataset CNC code for milling the relief of the object, and e) milling the work piece using this CNC code. The method can further be characterized in which a 3D image of the object is presented to an operator to define the boundaries at which the sculpture or relief will be cut-off.

In one embodiment of the invention does the system for creating a sculpture or a relief from an object comprises a) at the user side at least one digital camera, a computer, software, Internet connection and light; b) at the provider side a computer and render software capable of calculating a 3D object from various 2D images, a CNC machine, software to convert the calculated 3D objects into CNC code; and c) a logistic system capable of sending the sculpture or the relief to the user. The data transfer from the user to the provider takes place via Internet.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications.

I claim:

1. A method for providing a sculpture comprising the steps of
a) taking at least two 2D images of a subject,
b) applying an algorithm to create a 3D dataset of the surface of the subject,
c) defining boundaries and art style of the sculpture,
d) creating from this 3D dataset CNC code for milling the sculpture of the object, and
d) milling the work piece using this CNC code.

2. A method according to claim 1, in which a 3D image of the object is graphically presented to an operator to define the boundaries at which the sculpture or relief will be cut-off.

3. A method for creating a sculpture or relief consists of the steps of
a) taking at least two 2D images of a subject,
b) applying an algorithm to create a 3D dataset of the surface of the subject leaving a flat background,
c) defining boundaries and art style of the relief,
d) creating from this 3D dataset CNC code for milling the relief of the object, and
e) milling the work piece using this CNC code.

4. A method according to claim 3, in which a 3D image of the object is presented to an operator to define the boundaries at which the sculpture or relief will be cut-off.

5. A system for creating a sculpture or a relief from an object comprising
a) at the user side at least one digital camera, a computer, software Internet connection and light;
b) at the provider side a computer and render software capable of calculating a 3D object from various 2D images,
a CNC machine, software to convert the calculated 3D objects into CNC code; and
c) a logistic system capable of sending the sculpture or the relief to the user.

6. A system according to claim 5, in which the data transfer from the user to the provider takes place via Internet.
